(19) United States
(12) Patent Application Publication
(10) Pub. No.: US 2026/0117008 A1
(43) Pub. Date: Apr. 30, 2026

(54) Thermoplastic Resin, Preparation Method Therefor, and Use Thereof

(71) Applicant: TOPOLEFIN TECHNOLOGY (QUZHOU) CO., LTD., Zhejiang (CN)

(72) Inventors: Song Guo, Zhejiang (CN); Guo Wang, Zhejiang (CN); Ganhong Du, Zhejiang (CN)

(73) Assignee: TOPOLEFIN TECHNOLOGY (QUZHOU) CO., LTD., Zhejiang (CN)

(21) Appl. No.: 19/146,763

(22) PCT Filed: Nov. 21, 2024
(86) PCT No.: PCT/CN2024/133408

§ 371 Date: Jul. 9, 2025

(30) Foreign Application Priority Data
May 8, 2024 (CN) 202410558652.0

(51) Int. Cl. C08F 216/08; C08F 4/08; C08F 4/10; C08J 5/12; C08J 5/18

(52) U.S. Cl. CPC C08F 216/085; C08F 4/08; C08F 4/10; C08J 5/12; C08J 5/18; C08J 2329/06

(57) ABSTRACT

Provided are a thermoplastic resin, a preparation method therefor, and use thereof, which belong to the field of optical resin. The thermoplastic resin is prepared from raw materials including at least one of a carbonic acid diester compound or a dicarboxylic acid compound and a dihydroxy compound. By making the content of specific triptycene framework compounds in the raw materials lower than a certain specific value, a thermoplastic resin with excellent optical performance, low fluidity and yellowness is prepared.

### TECHNICAL FIELD

The present application belongs to the field of optical resins and, in particular, relates to a thermoplastic resin, a preparation method therefor, and use thereof.

### BACKGROUND

Optical plastic, also known as optical resin, is a conventional optical material that demonstrates excellent optical properties, mechanical characteristics, thermal performance and chemical properties, and with easy synthesis processes, simplified molding techniques and low manufacturing costs, it has emerged as one of the three fundamental materials competing with optical glass in the production of optical lenses. Currently, optical lenses prepared from optical plastics have occupied half of the global market share, particularly dominating the small and microlens sectors.

Current optical resin materials primarily consist of cycloolefin polymers and optical-grade polycarbonate. Notably, optical-grade polycarbonate occupies a pivotal position in optical lens applications due to its distinctive advantages of mass lightweighting characteristics, exceptional optical and mechanical performance and facile processability.

CN109476835A discloses a polycarbonate using 9,9-bis[6-(2-hydroxyethoxy)naphthyl]fluorene and 2,2′-bis(2-hydroxyethoxy)-1,1′-binaphthyl as monomers. The introduction of 9,9-bis[6-(2-hydroxyethoxy)naphthyl]fluorene and 2,2′-bis(2-hydroxyethoxy)-1,1′-binaphthyl significantly improves the refractive index of the polycarbonate, but leads to the high viscosity of the reaction system and enhanced rigidity of the polymer, thereby affecting the actual processing and molding. CN113667110A discloses the introduction of a nitrogen element and a benzene ring structure to improve the refractive index of polycarbonate and the employment of a spiro structure to enhance moldability. Nevertheless, this approach results in compromised yellowness properties. CN115725063A discloses a polymer 1,4-dihydroxyethoxytriptycene (DHTC) containing a triptycene skeleton. The resin containing a triptycene skeleton demonstrates a superior refractive index compared to resin containing a fluorene framework and thus becomes suitable for the application to optical materials. However, such resin exhibits limitations in fluidity and yellowness.

Therefore, there is an urgent need in the art to develop a thermoplastic resin with a high refractive index, low fluidity and low yellowness.

### SUMMARY

The present application provides a thermoplastic resin, a preparation method therefor, and use thereof, and the thermoplastic resin has a high refractive index, low fluidity and low yellowness.

In a first aspect, the present application provides a thermoplastic resin. The thermoplastic resin is prepared from raw materials including at least one of a carbonic acid diester or a dicarboxylic acid compound and a dihydroxy compound;
wherein the dihydroxy compound includes: a dihydroxy compound represented by Formula (1); and
any one or a combination of at least two of a compound represented by Formula (A), a compound represented by Formula (B) or a compound represented by Formula (C).

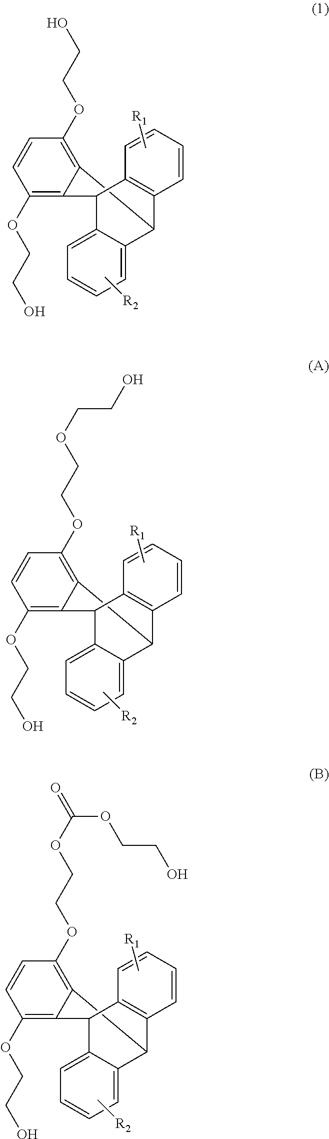

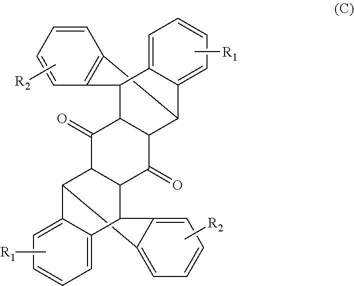

In Formula (1), Formula (A), Formula (B) and Formula (C), R₁ and R₂ are each independently selected from a hydrogen atom, alkyl having 1 to 20 (for example, 1, 2, 3, 4, 5, 6, 7, 8, 9, 10, 11, 12, 13, 14, 15, 16, 17, 18, 19 or 20) carbon atoms, alkoxy having 1 to 20 (for example, 1, 2, 3, 4, 5, 6, 7, 8, 9, 10, 11, 12, 13, 14, 15, 16, 17, 18, 19 or 20) carbon atoms, cycloalkyl having 5 to 20 (for example, 5, 6, 7, 8, 9, 10, 11, 12, 13, 14, 15, 16, 17, 18, 19 or 20) carbon atoms, cycloalkoxy having 5 to 20 (for example, 5, 6, 7, 8, 9, 10, 11, 12, 13, 14, 15, 16, 17, 18, 19 or 20) carbon atoms, aryl having 6 to 20 (for example, 6, 7, 8, 9, 10, 11, 12, 13, 14, 15, 16, 17, 18, 19 or 20) carbon atoms, or aryloxy (for example, 6, 7, 8, 9, 10, 11, 12, 13, 14, 15, 16, 17, 18, 19 or 20) having 6 to 20 carbon atoms.

The total weight of the compound represented by Formula (A), the compound represented by Formula (B) and the compound represented by Formula (C) is 1500 ppm or less with respect to 100 parts by weight of the dihydroxy compound represented by Formula (1), for example, 1500 ppm, 1450 ppm, 1400 ppm, 1350 ppm, 1300 ppm, 1250 ppm, 1200 ppm, 1150 ppm, 1100 ppm, 1050 ppm, 1000 ppm, 900 ppm, 800 ppm, 700 ppm, 600 ppm, 500 ppm, etc.

The thermoplastic resin containing compound structural units derived from the triptycene skeleton represented by Formula (1) exhibits a high refractive index, making the thermoplastic resin suitable for optical materials. It is revealed in the synthesis process that the compound represented by Formula (A), the compound represented by Formula (B) and/or the compound represented by Formula (C) may serve as plasticizers to improve the fluidity of the thermoplastic resin and by reducing the content of the compound represented by Formula (C) in the raw materials, the yellowness of the thermoplastic resin can be decreased significantly.

During the synthesis of the dihydroxy compound represented by Formula (1), the compound represented by Formula (A), the compound represented by Formula (B) and/or the compound represented by Formula (C) may serve as impurity by-products. Generally, in a chemical reaction including a polymerization reaction, the higher the purity of the raw material, the better. However, when the thermoplastic resin contains a trace amount of the compound represented by Formula (A), the compound represented by Formula (B) and/or the compound represented by Formula (C), a resin having excellent fluidity may be obtained. It is worth noting that if the amount of the compound represented by Formula (A), the compound represented by Formula (B) and/or the compound represented by Formula (C) is excessively increased, the glass transition temperature and the molecular weight of the thermoplastic resin fall below required standards, thereby resulting in product embrittlement, degraded mechanical properties and increased yellowness.

Therefore, it is necessary to balance the content of the compound represented by Formula (1) and the contents of the compound represented by Formula (A), the compound represented by Formula (B) and the compound represented by Formula (C).

In addition, various by-product compounds having a triptycene structure are also obtained as by-product impurities formed during the synthesis process. In addition to the compound represented by Formula (A), the compound represented by Formula (B) and the compound represented by Formula (C), the by-product compounds are represented by the following formulas:

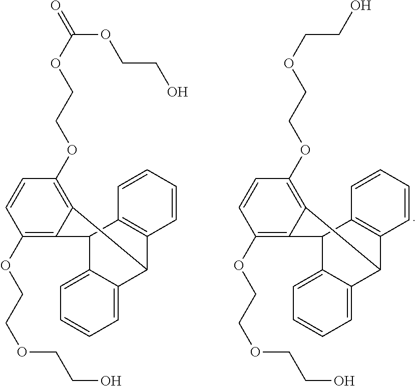 [SMILES: O=C(OCCO)OCCOc1ccc(OCCOCCO)c2c1C1c3ccccc3C2c2ccccc21 ; OCCOCCOc1ccc(OCCOCCO)c2c1C1c3ccccc3C2c2ccccc21]

During the synthesis experiment, impurities should be thoroughly removed, especially the compound represented by Formula (A) and the compound represented by Formula (B) as they may affect the fluidity of the resin. However, when the contents of the compound represented by Formula (A) and the compound represented by Formula (B) are restricted to specified levels, the properties of the thermoplastic resin can be improved.

In dihydroxy compounds, there is no particular limitation on the method for setting the content of the compound represented by Formula (A), Formula (B), and/or Formula (C) to a certain amount. For example: the compound represented by Formula (A), Formula (B), and/or Formula (C) may be added to the dihydroxy compound used as a raw material, thereby controlling the content of the compound represented by Formula (A), Formula (B), and/or Formula (C); or a method of using a low-purity dihydroxy compound containing a certain amount of the compound represented by Formula (A), Formula (B), and/or Formula (C); adjusting the synthesis conditions of the dihydroxy compound represented by Formula (1), for example, setting the reaction temperature and reaction time to 150-200° C. and 1-10 hours, respectively; changing melt polymerization to different solution polymerization, for example, using N-methylpyrrolidone (NMP), dimethylformamide (DMF), dimethyl sulfoxide (DMSO), etc.; adjusting the purification conditions after synthesis, for example, adjusting the number of water washes; adjusting the solvent during water washing, for example, tetrahydrofuran (THF), dichloromethane; setting the temperature of the water used for washing to 50˜90° C.; methods for controlling the crystallization rate after the reaction, etc.

Preferably, a weight of the compound represented by Formula (A) is 800 ppm or less with respect to 100 parts by weight of the dihydroxy compound represented by Formula (1), for example, 800 ppm, 790 ppm, 780 ppm, 770 ppm, 750 ppm, 700 ppm, 600 ppm, 500 ppm, 400 ppm, 300 ppm, 200 ppm, 100 ppm, 50 ppm, 10 ppm, 5 ppm, 1 ppm, etc.

Preferably, a weight of the compound represented by Formula (B) is 300 ppm or less with respect to 100 parts by weight of the dihydroxy compound represented by Formula (1), for example, 300 ppm, 290 ppm, 280 ppm, 270 ppm, 260 ppm, 250 ppm, 200 ppm, 150 ppm, 100 ppm, 50 ppm, 40 ppm, 30 ppm, 20 ppm, 10 ppm, 5 ppm, 1 ppm, etc.

Preferably, a weight of the compound represented by Formula (C) is 200 ppm or less with respect to 100 parts by weight of the dihydroxy compound represented by Formula (1), for example, 200 ppm, 190 ppm, 180 ppm, 170 ppm, 160 ppm, 150 ppm, 140 ppm, 130 ppm, 120 ppm, 110 ppm, 100 ppm, 50 ppm, 40 ppm, 30 ppm, 20 ppm, 10 ppm, 5 ppm, 1 ppm, etc.

Preferably, a proportion of the dihydroxy compound represented by Formula (1) is 1 mol % to 99.9 mol % based on the total substance amount of the dihydroxy compound being 100 mol %, for example, 1 mol %, 5 mol %, 10 mol %, 20 mol %, 30 mol %, 40 mol %, 50 mol %, 60 mol %, 70 mol %, 80 mol %, 90 mol %, 99.9 mol %, etc., preferably 45 mol % to 99.9 mol %, and more preferably 55 mol % to 99.9 mol %.

Preferably, the dihydroxy compound further includes a dihydroxy compound represented by Formula (2) and/or a dihydroxy compound represented by Formula (3);

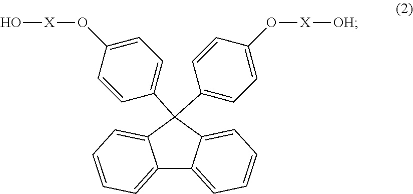

wherein in Formula (2), X is each independently alkylene having 1 to 4 (for example, 1, 2, 3 or 4) carbon atoms;

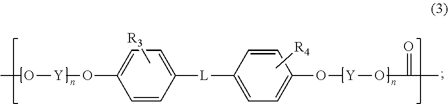

wherein in Formula (3), R₃ and R₄ are each independently selected from a hydrogen atom, alkyl having 1 to 20 (for example, 1, 2, 3, 4, 5, 6, 7, 8, 9, 10, 11, 12, 13, 14, 15, 16, 17, 18, 19 or 20) carbon atoms, alkoxy having 1 to 20 (for example, 1, 2, 3, 4, 5, 6, 7, 8, 9, 10, 11, 12, 13, 14, 15, 16, 17, 18, 19 or 20) carbon atoms, cycloalkoxy having 5 to 20 (for example, 5, 6, 7, 8, 9, 10, 11, 12, 13, 14, 15, 16, 17, 18, 19 or 20) carbon atoms, aryl having 6 to 20 (for example, 6, 7, 8, 9, 10, 11, 12, 13, 14, 15, 16, 17, 18, 19 or 20) carbon atoms, aryloxy having 6 to 20 (for example, 6, 7, 8, 9, 10, 11, 12, 13, 14, 15, 16, 17, 18, 19 or 20) carbon atoms or a halogen atom;
Y is selected from alkylene having 1 to 8 (for example, 1, 2, 3, 4, 5, 6, 7 or 8) carbon atoms, cycloalkylene having 6 to 10 (for example, 6, 7, 8, 9 or 10) carbon atoms or arylene having 6 to (for example, 6, 7, 8, 9 or 10) carbon atoms, and n is an integer of 0 to 5 (for example, 0, 1, 2, 3, 4 or 5);
L is selected from a single bond or any one of the following groups:

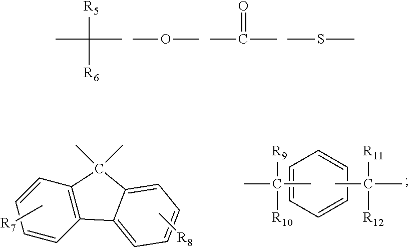

wherein R₅, R₆ and R₉ to R₁₂ are each independently selected from a hydrogen atom, alkyl having 1 to 10 (for example, 1, 2, 3, 4, 5, 6, 7, 8, 9 or 10) carbon atoms or phenyl; R₇ and R₈ each independently represent a hydrogen atom or alkyl having 1 to 5 (for example, 1, 2, 3, 4 or 5) carbon atoms.

Preferably, a molar ratio of the dihydroxy compound represented by Formula (1) to the dihydroxy compound represented by Formula (2) is 20:80 to 99.9:0.1, for example, 20:80, 25:75, 30:70, 35:65, 40:60, 45:55, 50:50, 55:45, 60:40, 65:35, 70:30, 75:25, 80:20, 90:10, 95:5, 99.9:0.1, etc., preferably 30:70 to 99.5:0.5, and further preferably 40:60 to 99:1.

Preferably, a number average molecular weight of the thermoplastic resin is 10000 to 50000, for example, 10000, 10000, 15000, 20000, 25000, 30000, 35000, 40000, 45000, 50000, etc., preferably 15000 to 25000, and further preferably 17500 to 20000.

By controlling the number average molecular weight of the thermoplastic resin within the range of 10000 to 50000, the resulting molded body can be prevented from being excessively brittle, thereby avoiding molding failures. Moreover, the melt viscosity does not become too high so that the resin can be easily demolded from the mold during the molding process, maintains good fluidity and becomes suitable for injection molding in the molten state.

Preferably, a glass transition temperature of the thermoplastic resin is 95° C. to 180° C., for example, 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., etc., preferably 110° C. to 170° C., further preferably 130° C. to 160° C., and particularly preferably 140° C. to 150° C.

If the glass transition temperature of the thermoplastic resin exceeds 180° C., the melt temperature of the resin becomes higher, thereby making the resin prone to decomposition or coloration.

Moreover, in a case where the glass transition temperature of the resin is excessively high, the temperature difference between the mold temperature in general-purpose mold temperature controllers and the glass transition temperature of the resin increases significantly.

Preferably, a phenol content of the thermoplastic resin is 0.1 ppm to 1000 ppm, for example, 0.1 ppm, 1 ppm, 10 ppm, 50 ppm, 100 ppm, 200 ppm, 300 ppm, 400 ppm, 500 ppm, 600 ppm, 700 ppm, 800 ppm, 900 ppm, 1000 ppm, etc., preferably 0.1 ppm to 500 ppm, and further preferably 0.1 ppm to 300 ppm.

Preferably, the carbonic acid diester is any one or a combination of at least two of diphenyl carbonate, ditolyl carbonate, bis(chlorophenyl)carbonate, m-cresyl carbonate, dimethyl carbonate, diethyl carbonate, dibutyl carbonate or dicyclohexyl carbonate.

Preferably, the dicarboxylic acid compound is any one or a combination of at least two of 2,7-naphthalenedicarboxylic acid, 2,6-naphthalenedicarboxylic acid, 2,3-naphthalenedicarboxylic acid, 1,8-naphthalenedicarboxylic acid, 1,4-naphthalenedicarboxylic acid, terephthalic acid, isophthalic acid, phthalic acid, 2-methylterephthalic acid, biphenyldicarboxylic acid, tetranaphthalenedicarboxylic acid, fluorene-9,9-dipropionic acid, oxalic acid, malonic acid, succinic acid, maleic acid, fumaric acid, glutaric acid, adipic acid, pimelic acid, octanedioic acid, nonanedioic acid, decanedioic acid, decanedicarboxylic acid, dodecanedicarboxylic acid, cyclohexanedicarboxylic acid, decahydronaphthalenedicarboxylic acid, norbornanedicarboxylic acid, tricyclodecanedicarboxylic acid, pentacyclododecanedicarboxylic acid, 3,9-bis(1,1-dimethyl-2-carboxyethyl)-2,4,8,10-tetraoxaspiro[5,5]undecane or 5-carboxy-5-ethyl-2-(1,1-dimethyl-2-carboxyethyl)-1,3-dioxane or dimer acid.

Preferably, a total amount of at least one of the carbonic acid diester or the dicarboxylic acid compound is 0.97 mol to 1.20 mol with respect to 1 mol of the dihydroxy compound, for example, 0.97 mol, 0.98 mol, 0.99 mol, 1.00 mol, 1.05 mol, 1.10 mol, 1.15 mol, 1.20 mol, etc., and preferably 0.98 mol to 1.10 mol.

Preferably, the thermoplastic resin further includes an antioxidant, a processing stabilizer, a light stabilizer, a polymeric metal passivator, a flame retardant, a slip agent, an antistat, a surfactant, an antibacterial agent, a release agent, an ultraviolet absorber, a plasticizer or a solubilizer.

Preferably, the antioxidant is any one or a combination of at least two of triethylene glycol-bis[3-(3-tert-butyl-5-methyl-4-hydroxyphenyl)propionate], 1,6-hexanediol-bis[3-(3,5-di-tert-butyl-4-hydroxyphenyl)propanoate], pentaerythritol-tetra[3-(3,5-di-tert-butyl-4-hydroxyphenyl)propanoate], octadecyl-3-(3,5-di-tert-butyl-4-hydroxyphenyl)propanoate, 1,3,5-trimethyl-2,4,6-tris(3,5-di-tert-butyl-4-hydroxybenzyl)benzene, N,N-hexamethylene dis(3,5-di-tert-butyl-4-hydroxy-hydrocinnamamide), 3,5-di-tert-butyl-4-hydroxy-benzylphosphonate-diethyl ester, tris(3,5-di-tert-butyl-4-hydroxybenzyl)isocyanurate or 3,9-bis{1,1-dimethyl-2-[13-(3-tert-butyl-4-hydroxy-5-methylphenyl)propionyloxy]ethyl}-2,4,8,10-tetraoxaspiro[5,5]undecane.

Preferably, a content of the antioxidant is 0.001 parts by weight to 0.1 parts by weight with respect to 100 parts by weight of the thermoplastic resin, for example, 0.001 parts by weight, 0.005 parts by weight, 0.01 parts by weight, 0.02 parts by weight, 0.03 parts by weight, 0.04 parts by weight, 0.05 parts by weight, 0.06 parts by weight, 0.07 parts by weight, 0.08 parts by weight, 0.09 parts by weight or 0.1 parts by weight.

Preferably, the processing stabilizer is a phosphorus-based processing heat stabilizer and/or a sulfur-based processing heat stabilizer.

Preferably, the phosphorus-based processing heat stabilizer is any one or a combination of at least two of triphenyl phosphite, tris(nonylphenyl)phosphite, tris(2,4-di-tert-butylphenyl)phosphite, tris(2,6-di-tert-butylphenyl)phosphite, tridecyl phosphite, trioctyl phosphite, trioctadecyl phosphite, didecyl monophenyl phosphite, dioctyl monophenyl phosphite, diisopropyl monophenyl phosphite, monobutyl diphenyl phosphite, monodecyl diphenyl phosphite, monooctyl diphenyl phosphite, bis(2,6-di-tert-butyl-4-methylphenyl)pentaerythritol diphosphite, 2,2-methylenebis(4,6-di-tert-butylphenyl)octyl phosphite, di(nonylphenyl)pentaerythritol diphosphite, di(2,4-dicumylphenyl)pentaerythritol diphosphite, di(2,4-di-tert-butylphenyl)pentaerythritol diphosphite, distearyl pentaerythritol diphosphite, tributyl phosphate, triethyl phosphate, trimethyl phosphate, triphenyl phosphate, diphenyl mono-biphenyl phosphate, dibutyl phosphate, dioctyl phosphate, diisopropyl phosphate, dimethyl phenylphosphonate, diethyl phenylphosphonate, tetra(2,4-di-tert-butylphenyl)-4,4′-biphenyl diphosphonite, tetra(2,4-di-tert-butylphenyl)-4,3-biphenyl diphosphonite, tetra(2,4-di-tert-butylphenyl)-3,3′-biphenyl diphosphonite, bis(2,4-di-tert-butylphenyl)-4-phenyl-phenyl phosphonite or bis(2,4-di-tert-butylphenyl)-3-phenyl-phenyl phosphonate.

Preferably, a content of the phosphorus-based processing heat stabilizer is 0.001 parts by weight to 0.1 parts by weight with respect to 100 parts by weight of the thermoplastic resin, for example, 0.001 parts by weight, 0.005 parts by weight, 0.01 parts by weight, 0.02 parts by weight, 0.03 parts by weight, 0.04 parts by weight, 0.05 parts by weight, 0.06 parts by weight, 0.07 parts by weight, 0.08 parts by weight, 0.09 parts by weight or 0.1 parts by weight.

Preferably, the sulfur-based processing heat stabilizer is any one or a combination of at least two of pentaerythritol-tetra(3-laurylthiopropionate), pentaerythritol-tetra(3-myristylthiopropionate), pentaerythritol-tetra(3-stearylthiopropionate), dilauryl-3,3′-thiodipropionate, dimyristyl-3,3′-thiodipropionate or distearyl-3,3′-thiopropionate.

Preferably, a content of the sulfur-based processing heat stabilizer is 0.001 parts by weight to 0.1 parts by weight with respect to 100 parts by weight of the thermoplastic resin, for example, 0.001 parts by weight, 0.005 parts by weight, 0.01 parts by weight, 0.02 parts by weight, 0.03 parts by weight, 0.04 parts by weight, 0.05 parts by weight, 0.06 parts by weight, 0.07 parts by weight, 0.08 parts by weight, 0.09 parts by weight or 0.1 parts by weight.

Preferably, 90% by weight or more of the release agent is an ester.

Preferably, the ester is prepared by reacting a fatty acid and an alcohol.

Preferably, the alcohol includes a monohydric alcohol having 1 to 20 (for example, 1, 2, 3, 4, 5, 6, 7, 8, 9, 10, 11, 12, 13, 14, 15, 16, 17, 18, 19 or 20) carbon atoms and/or a polyhydric alcohol having 1 to 25 (for example, 1, 2, 3, 4, 5, 6, 7, 8, 9, 10, 11, 12, 13, 14, 15, 16, 17, 18, 19, 20, 21, 22, 23, 24 or 25) carbon atoms.

Preferably, the fatty acid is a saturated fatty acid having 10 to 30 (for example, 10, 11, 12, 13, 14, 15, 16, 17, 18, 19, 20, 21, 22, 23, 24, 25, 26, 27, 28, 29 or 30) carbon atoms.

Preferably, a content of the release agent is 0.005 parts by weight to 1.5 parts by weight with respect to 100 parts by weight of the thermoplastic resin, for example, 0.005 parts by weight, 0.01 parts by weight, 0.1 parts by weight, 0.2 parts by weight, 0.3 parts by weight, 0.4 parts by weight, 0.5 parts by weight, 0.6 parts by weight, 0.7 parts by weight, 0.8 parts by weight, 0.9 parts by weight, 1 part by weight, 1.1 parts by weight, 1.2 parts by weight, 1.3 parts by weight, 1.4 parts by weight, 1.5 parts by weight, etc., preferably 0.01 parts by weight to 0.6 parts by weight, and more preferably 0.05 parts by weight to 0.1 parts by weight.

Preferably, the ultraviolet absorber includes any one or a combination of at least two of a benzotriazole-based ultraviolet absorber, a benzophenone-based ultraviolet absorber, a triazine-based ultraviolet absorber, a cyclic imide ester-based ultraviolet absorber or an acrylate-based ultraviolet absorber containing nitrogen element.

Preferably, a content of the ultraviolet absorber is 0.01 parts by weight to 3.0 parts by weight with respect to 100 parts by weight of the thermoplastic resin, for example, 0.01 parts by weight, 0.1 parts by weight, 0.5 parts by weight, 1.0 parts by weight, 1.5 parts by weight, 2.0 parts by weight, 2.5 parts by weight, 3.0 parts by weight, etc., preferably 0.05 parts by weight to 1.5 parts by weight, and more preferably 0.1 parts by weight to 0.5 parts by weight. As long as the content of the ultraviolet absorber is controlled within the above range, excellent weather resistance can be imparted to the thermoplastic resin.

Preferably, the thermoplastic resin is any one or a combination of at least two of a polyester resin, a polyestercarbonate resin or a polycarbonate resin and is preferably a polycarbonate resin in consideration of heat resistance and hydrolysis resistance.

Optical properties such as refractive index, Abbe number and birefringence value are more significantly affected by the chemical structure of structural units and less affected by whether the chemical bonds between the structural units are ester bonds or carbonate bonds. In addition, the presence of impurities leads to increased saturated water absorption or a reduced polymerization rate, which is more significantly affected by the chemical structure of the structural units of the resin and less affected by differences in the chemical bonds between the structural units.

In a second aspect, the present application provides a preparation method for the thermoplastic resin described in the first aspect. The preparation method includes the following steps.
mixing raw materials for preparing a thermoplastic resin and performing a reaction to obtain the thermoplastic resin.

Preferably, the reaction is carried out in the presence of a catalyst.

Preferably, the catalyst is selected from any one or a combination of at least two of an alkali metal compound, an alkaline-earth metal compound or a nitrogen-containing compound.

Preferably, the alkali metal compound is any one or a combination of at least two of sodium hydroxide, potassium hydroxide, cesium hydroxide, lithium hydroxide, sodium bicarbonate, sodium carbonate, potassium carbonate, cesium carbonate, lithium carbonate, sodium acetate, potassium acetate, cesium acetate, lithium acetate, sodium stearate, potassium stearate, cesium stearate, lithium stearate, lithium borohydride, sodium phenylborate, sodium benzoate, potassium benzoate, cesium benzoate, lithium benzoate, disodium hydrogen phosphate, dipotassium hydrogen phosphate, dilithium hydrogen phosphate, disodium phenyl phosphate, a disodium salt, a dipotassium salt, a dicesium salt or a dilithium salt of bisphenol A, or a sodium salt, a potassium salt, a cesium salt or a lithium salt of phenol, and is preferably sodium hydroxide and/or sodium bicarbonate.

Preferably, an amount of the catalyst used is such that the molar ratio of the total of a compound having a structure represented by Formula (1) to the catalyst is 1:(10-7 to 10-5).

Preferably, the reaction is carried out in the following reaction conditions: a resulting mixture is heated to 150° C. to 190° C. (for example, 150° C., 160° C., 170° C., 180° C., 190° C., etc.) under atmospheric pressure, the reaction is carried out for 5 min to 15 min (for example, 5 min, 10 min, 15 min, etc.), the pressure is reduced to 20 kPa to 30 kPa (for example, 20 kPa, 25 kPa, 30 kPa, etc.), and the reaction is continued for 20 min to 40 min (for example, 20 min, 30 min, 40 min etc.); the mixture is heated to 200° C. to 220° C. (for example, 200° C., 210° C., 220° C., etc.), the pressure is reduced to 10 kPa to 18 kPa (for example, 10 kPa, 14 kPa, 18 kPa, etc.), and the reaction is carried out for 15 min to 25 min (for example, 15 min, 20 min, 25 min, etc.); the mixture is heated to 230° C. to 270° C. (for example, 230° C., 250° C., 270° C., etc.), the pressure is reduced to 3 kPa to 6 kPa (for example, 3 kPa, 4 kPa, 5 kPa, 6 kPa, etc.), and the reaction is carried out for 10 min to 25 min (for example, 10 min, 15 min, 20 min, 25 min, etc.); the mixture is heated to 240° C. to 290° C. (for example, 250° C., 260° C., 270° C., 280° C., 290° C., etc.), the pressure is continuously reduced to 0.05 kPa to 0.5 kPa (for example, 0.1 kPa, 0.2 kPa, 0.3 kPa, 0.4 kPa, 0.5 kPa, etc.), and the reaction is continued for 50 min to 90 min (for example, 50 min, 60 min, 70 min, 80 min, 90 min, etc.); after the reaction is completed, the heating is stopped and nitrogen gas is introduced to obtain the thermoplastic resin.

Under an inert gas atmosphere, a dihydroxy compound and a carbonic acid diester are heated with stirring, molten and then polymerized while the produced alcohols or phenols are distilled off.

The reaction temperature typically ranges from 120° C. to 350° C., depending on the boiling points of the produced alcohols or phenols. Reduced pressure is employed in the initial reaction stages to facilitate the distilling of the produced alcohols or phenols, and a transesterification catalyst may be optionally used to enhance reaction kinetics. The reaction may be carried out in a continuous mode or a batchwise mode.

In a third aspect, the present application provides a molded body. The molded body is molded from the thermoplastic resin described in the first aspect, and the molded body includes a lampshade, an automobile lamp lens, a signboard, a laser printing film or a display lamp.

The thermoplastic resin of the present application may be used to prepare a molded body by a method such as injection molding, compression molding, extrusion molding or solution casting.

In a fourth aspect, the present application provides an optical material. The optical material is prepared from a raw material including the thermoplastic resin described in the first aspect.

In a fifth aspect, the present application provides an optical lens. The optical lens is prepared from a raw material including the thermoplastic resin described in the first aspect.

The thermoplastic resin of the present application may be used to prepare an optical lens by a method such as injection molding, compression molding or extrusion molding.

In a sixth aspect, the present application provides an optical film. The optical film is prepared from the thermoplastic resin described in the first aspect.

Compared with the related art, the present application at least has the following beneficial effects. By adding a specific amount of a triptycene skeleton compound into a dihydroxy compound having a specific triptycene skeleton, the fluidity and yellowness of the thermoplastic resin are significantly improved without affecting optical properties such as refractive index, Abbe number and birefringence of the thermoplastic resin.

### DETAILED DESCRIPTION

For a better understanding of the present application, examples of the compounds of the present disclosure are listed below. Those skilled in the art are to understand that the examples described herein are used for a better understanding of the present application and are not to be construed as specific limitations to the present application.

### Preparation Example 1

This preparation example provides a dihydroxy compound. 12.1 g of anthracene (112 mmol), 10 g of benzoquinone (56 mmol) and 100 mL of toluene were added to a glass reactor equipped with a stirrer, a nitrogen inlet, a thermometer and a reflux condenser and stirred at 110° C. under reflux for 3 h. After the reaction was completed, the reaction mixture was filtered to collect the filtrate. Ethanol was added to the filtrate for crystallization to obtain 1,4-dihydroxytriptycene as white powder, and 1,4-dihydroxytriptycene was subjected to transesterification with ethylene carbonate to obtain white crystal. 150 mL of toluene was added to the white crystal, and the resulting mixture was washed twice with 100 g of alkali solution at 80° C. The mixture was slowly cooled to room temperature, and the precipitated crystal was filtered and dried to obtain 1,4-dihydroxyethoxytriptycene (DHTC-1) as white crystal. The liquid chromatography-mass spectrometry (LC-MS) analysis showed that the purity of DHTC-1 was 99.5%, the content of the compound represented by Formula (A) was 800 ppm, the content of the compound represented by Formula (B) was 450 ppm, and the content of the compound represented by Formula (C) was 200 ppm.

### Preparation Example 2

This preparation example provides a dihydroxy compound. 12.1 g of anthracene (112 mmol), 10 g of benzoquinone (56 mmol) and 100 mL of toluene were added to a glass reactor equipped with a stirrer, a nitrogen inlet, a thermometer and a reflux condenser and stirred at 110° C. under reflux for 3 h. After the reaction was completed, the reaction mixture was filtered to collect the filtrate. Ethanol was added to the filtrate for crystallization to obtain 1,4-dihydroxytriptycene as white powder, and 1,4-dihydroxytriptycene was subjected to transesterification with ethylene carbonate to obtain white crystal. 150 mL of toluene was added to the white crystal, and the resulting mixture was washed five times with 100 g of alkali solution at 80° C. The mixture was filtered, added to 500 mL of dichloromethane and then subjected to precipitation with excess n-hexane, and the precipitated crystal was filtered and dried to obtain DHTC-2 as white crystal. The LC-MS analysis showed that the purity of DHTC-2 was 99.7%, the content of the compound represented by Formula (A) was 500 ppm, the content of the compound represented by Formula (B) was 250 ppm, and the content of the compound represented by Formula (C) was 200 ppm.

### Preparation Example 3

This preparation example provides a dihydroxy compound. 12.1 g of anthracene (112 mmol), 10 g of benzoquinone (56 mmol) and 100 mL of toluene were added to a glass reactor equipped with a stirrer, a nitrogen inlet, a thermometer and a reflux condenser and stirred at 110° C. under reflux for 3 h. After the reaction was completed, the reaction mixture was filtered to collect the filtrate. Ethanol was added to the filtrate for crystallization to obtain 1,4-dihydroxytriptycene as white powder, and 1,4-dihydroxytriptycene was subjected to transesterification with ethylene carbonate to obtain white crystal. 150 mL of toluene was added to the white crystal, and the resulting mixture was washed five times with 100 g of alkali solution at 80° C. The mixture was slowly cooled to room temperature, and the precipitated crystal was filtered and dried to obtain DHTC-3 as white crystal. The LC-MS analysis showed that the purity of DHTC-3 was 99.9%, the content of the compound represented by Formula (A) was 400 ppm, the content of the compound represented by Formula (B) was 200 ppm, and the content of the compound represented by Formula (C) was 100 ppm.

### Comparative Preparation Example 1

This comparative preparation example provides a dihydroxy compound. 12.1 g of anthracene (112 mmol), 10 g of benzoquinone (56 mmol) and 100 mL of toluene were added to a glass reactor equipped with a stirrer, a nitrogen inlet, a thermometer and a reflux condenser and stirred at 110° C. under reflux for 3 h. After the reaction was completed, the reaction mixture was filtered to collect the filtrate. Ethanol was added to the filtrate for crystallization to obtain 1,4-dihydroxytriptycene as white powder, and 1,4-dihydroxytriptycene was subjected to transesterification with ethylene carbonate, dissolved and recrystallized to obtain DHTC-4 as white powder. The LC-MS analysis showed that the purity of DHTC-4 was 97.7%, the content of the compound represented by Formula (A) was 5700 ppm, the content of the compound represented by Formula (B) was 4300 ppm, and the content of the compound represented by Formula (C) was 2500 ppm.

### Example 1

This example provides a thermoplastic resin. 1037.3 g of DHTC-3 (3.3 mol), 749.8 g of diphenyl carbonate (DPC, 3.5 mol) and sodium bicarbonate as a catalyst were added to a stainless steel reactor equipped with a stirrer and a distillation device. The pressure in the reactor was maintained at atmospheric level, the temperature in the reactor was raised to 170° C. within 20 min, and the reaction was carried out for 10 min. Then the pressure in the reactor was reduced to 25 kPa within 5 min, and the reaction was continued for 30 min. The temperature in the reactor was raised to 210° C. within 10 min, the pressure in the reactor was reduced to 15 kPa, and the reaction was carried out for 20 min. The temperature in the reactor was raised to 240° C. within 10 min, the pressure in the reactor was reduced to 5 kPa, and the reaction was carried out for 20 min. Finally, the temperature in the reactor was raised to 260° C. within 10 min, the pressure in the reactor was reduced to 0.1 kPa, and the reaction was continued for 60 min. Nitrogen gas was introduced into the reactor to restore the reaction system to atmospheric pressure to prepare a thermoplastic resin.

### Example 2

This example provides a thermoplastic resin. 902.4 g of DHTC-3 (2.871 mol), 91.9 g of 2,2-bis(4-hydroxyphenyl)propane (BPA, 0.429 mol), 728.4 g of diphenyl carbonate (3.4 mol) and sodium bicarbonate as a catalyst were added to a stainless steel reactor equipped with a stirrer and a distillation device. The pressure in the reactor was maintained at atmospheric level, the temperature in the reactor was raised to 190° C. within 20 min, and the reaction was carried out for 15 min. Then the pressure in the reactor was reduced to 20 kPa within 5 min, and the reaction was continued for 20 min. The temperature in the reactor was raised to 200° C. within 10 min, the pressure in the reactor was reduced to 12 kPa, and the reaction was carried out for 25 min. The temperature in the reactor was raised to 250° C. within 10 min, the pressure in the reactor was reduced to 6 kPa, and the reaction was carried out for 15 min. Finally, the temperature in the reactor was raised to 280° C. within 10 min, the pressure in the reactor was reduced to 0.2 kPa, and the reaction was continued for 80 min. Nitrogen gas was introduced into the reactor to restore the reaction system to atmospheric pressure to prepare a thermoplastic resin.

### Example 3

This example provides a thermoplastic resin. 902.4 g of DHTC-3 (2.871 mol), 188.1 g of 9,9-bis[4-(2-hydroxyethoxy)-3-phenyl]fluorene (BPEF, 0.429 mol), 642.7 g of diphenyl carbonate (3 mol) and sodium bicarbonate as a catalyst were added to a stainless steel reactor equipped with a stirrer and a distillation device. The pressure in the reactor was maintained at atmospheric level, the temperature in the reactor was raised to 180° C. within 20 min, and the reaction was carried out for 15 min. Then the pressure in the reactor was reduced to 20 kPa within 5 min, and the reaction was continued for 35 min. The temperature in the reactor was raised to 215° C. within 10 min, the pressure in the reactor was reduced to 18 kPa, and the reaction was carried out for 25 min. The temperature in the reactor was raised to 230° C. within 10 min, the pressure in the reactor was reduced to 3 kPa, and the reaction was carried out for 10 min. Finally, the temperature in the reactor was raised to 240° C. within 10 min, the pressure in the reactor was reduced to 0.05 kPa, and the reaction was continued for 50 min. Nitrogen gas was introduced into the reactor to restore the reaction system to atmospheric pressure to prepare a thermoplastic resin.

### Example 4

This example provides a thermoplastic resin. Example 4 differs from Example 1 only in that DHTC-1 was used, and other conditions are exactly the same as those in Example 1.

### Example 5

This example provides a thermoplastic resin. Example 5 differs from Example 2 only in that DHTC-1 was used, and other conditions are exactly the same as those in Example 2.

### Example 6

This example provides a thermoplastic resin. Example 6 differs from Example 3 only in that DHTC-1 was used, and other conditions are exactly the same as those in Example 3.

### Example 7

This example provides a thermoplastic resin. Example 7 differs from Example 1 only in that DHTC-2 was used, and other conditions are exactly the same as those in Example 1.

### Example 8

This example provides a thermoplastic resin. Example 8 differs from Example 2 only in that DHTC-2 was used, and other conditions are exactly the same as those in Example 2.

### Example 9

This example provides a thermoplastic resin. Example 9 differs from Example 3 only in that DHTC-2 was used, and other conditions are exactly the same as those in Example 3.

### Comparative Example 1

This comparative example provides a thermoplastic resin. Comparative Example 1 differs from Example 1 only in that DHTC-4 was used, and other conditions are exactly the same as those in Example 1.

### Comparative Example 2

This comparative example provides a thermoplastic resin. Comparative Example 2 differs from Example 2 only in that DHTC-4 was used, and other conditions are exactly the same as those in Example 2.

### Comparative Example 3

This comparative example provides a thermoplastic resin. Comparative Example 3 differs from Example 3 only in that DHTC-4 was used, and other conditions are exactly the same as those in Example 3.

### Application Example 1

The thermoplastic resin in Example 2 was dissolved in dichloromethane to obtain a resin solution having a solid content concentration of 5 wt %. The resin solution was cast into a cast film production mold, and after dichloromethane was volatilized, the resin was peeled off and dried to obtain a cast film having a thickness of 0.1 mm.

### Application Example 2

The thermoplastic resin in Example 3 was dissolved in dichloromethane to obtain a resin solution having a solid content concentration of 5 wt %. The resin solution was cast into a cast film production mold, and after dichloromethane was volatilized, the resin was peeled off and dried to obtain a cast film having a thickness of 0.1 mm.

### Comparative Application Example 1

The thermoplastic resin (Mitsubishi Chemical, EP5000) was dissolved in dichloromethane to obtain a resin solution having a solid content concentration of 5 wt %. The resin solution was cast into a cast film production mold, and after dichloromethane was volatilized, the resin was peeled off and dried to obtain a cast film having a thickness of 0.1 mm.

### Performance Test

The test was carried out in the following methods.
(1) Melt volume-flow rate (MVR): MVR represents an index of the fluidity of a resin or a resin composition. The greater the value, the higher the fluidity. The thermoplastic resin was vacuum-dried at 120° C. for 4 h and then measured using an Instron™ melt indexer at a temperature of 260° C. and a load of 2160 g.
(2) Purity and impurity content: 20 mg of DHTC was dissolved in 10 mL of methanol and filtered using a 0.20 μm polytetrafluoroethylene (PTFE) filter. The resulting compound was analyzed using Liquid Chromatography Mass Spectrometry (LC-MS), and the purity was calculated as the ratio of the peak area of the compound to the total peak area.
(3) Tensile strength: The thermoplastic resin was dissolved in dichloromethane at a concentration of 5 wt % and cast onto a leveled casting plate. Then, the evaporation amount of the solvent from the casting solution was adjusted while the solvent was volatilized to obtain a transparent film having a thickness of about 100 μm. The film was sufficiently dried using a vacuum dryer at a temperature equal to or lower than the glass transition temperature. The film was measured according to ASTM D882-61T using a universal tensile tester.
(4) Yellowness: The yellowness was measured using a CS-820N benchtop spectrophotometer.
(5) Total luminous transmittance and haze: The total luminous transmittance and the haze were measured using an EVERFINE™ HAM-200 hazemeter.
(6) Glass transition temperature: The glass transition temperature was measured using a differential scanning calorimeter (DSC).
(7) Refractive index: The refractive index of the film having a thickness of 0.1 mm at a wavelength of 589 mn and 23° C. was measured using an Abbe refractometer.
(8) Abbe number: The refractive indexes of the film having a thickness of 0.1 mm at wavelengths of 486 nm, 589 nm and 656 nm and 23° C. were measured using an Abbe refractometer, and then the Abbe number was calculated according to the following formula:

$$v = ( {n}_{D} - 1 ) / ( {n}_{F} - {n}_{C} )$$

n_{D}: Refractive index at the wavelength of 589 nm;
n_{C}: Refractive index at the wavelength of 656 nm;
n_{F}: Refractive index at the wavelength of 486 nm.

### Test Results

TABLE 1

| | | | | | | | Physical properties of resin | | |
|---|---|---|---|---|---|---|---|---|---|
| | DHTC | | | | | | Number | | |
| | | | (A) | (B) | (C) | | average | MVR | |
| | | Purity | content | content | content | Dihydroxy | molecular | (cm³/10 | |
| | Type | % | ppm | ppm | ppm | comonomer | weight | min) | Yellowness |
| Example 1 | DHTC-3 | 99.9 | 400 | 200 | 100 | DPC | 15500 | 45 | 1.19 |
| Example 2 | DHTC-3 | 99.9 | 400 | 200 | 100 | BPA, DPC | 16300 | 46 | 1.12 |
| Example 3 | DHTC-3 | 99.9 | 400 | 200 | 100 | BPEF, DPC | 18000 | 43 | 1.15 |
| Example 4 | DHTC-1 | 99.5 | 800 | 450 | 200 | DPC | 16350 | 50 | 5.00 |
| Example 5 | DHTC-1 | 99.5 | 800 | 450 | 200 | BPA, DPC | 17740 | 48 | 5.03 |
| Example 6 | DHTC-1 | 99.5 | 800 | 450 | 200 | BPEF, DPC | 17900 | 45 | 5.02 |
| Example 7 | DHTC-2 | 99.7 | 500 | 250 | 200 | DPC | 17830 | 48 | 2.87 |
| Example 8 | DHTC-2 | 99.7 | 500 | 250 | 200 | BPA, DPC | 17330 | 47 | 2.83 |
| Example 9 | DHTC-2 | 99.7 | 500 | 250 | 200 | BPEF, DPC | 18080 | 47 | 2.83 |
| Comparative | DHTC-4 | 97.7 | 5700 | 4300 | 2500 | DPC | 8830 | 75 | 11.58 |
| Example 1 | | | | | | | | | |
| Comparative | DHTC-4 | 97.7 | 5700 | 4300 | 2500 | BPA, DPC | 8350 | 77 | 12.36 |
| Example 2 | | | | | | | | | |
| Comparative | DHTC-4 | 97.7 | 5700 | 4300 | 2500 | BPEF, DPC | 9530 | 70 | 11.43 |
| Example 3 | | | | | | | | | |

As can be seen from the analysis of data in Table 1, taking Examples 1 to 9 as an example, the number average molecular weight of the thermoplastic resin described in the present application is 15500 to 18000, the MVR is 43 cm³/10 min to 50 cm³/10 min, and the yellowness is 1.12 to 5.03.

As can be seen from the comparison of Comparative Examples 1 to 3 with Example 1, since Comparative Examples 1 to 3 use raw materials containing 12500 ppm of the compounds represented by Formulas (A) to (C), the MVRs of the thermoplastic resins are increased from 45 cm³/10 min to 77 cm³/10 min, and the yellowness is increased from 1.19 to 12.36.

As can be seen from the analysis of Examples 1 to 9, in Examples 7 to 9, the total content of the compounds represented by Formulas (A) to (C) is less than 1000 ppm, the MVRs of the thermoplastic resins ranges from 47 cm³/10 min to 48 cm³/10 min, and the yellowness ranges from 2.83 to 2.87; in Examples 4 to 6, the total content of the compounds represented by Formulas (A) to (C) is less than 1500 ppm, the MVRs of the thermoplastic resins ranges from 45 cm³/10 min to 50 cm³/10 min, and the yellowness ranges from 5.00 to 5.03; in Examples 1 to 3, the total content of the compounds represented by Formulas (A) to (C) is less than 800 ppm, the MVRs of the thermoplastic resins ranges from 43 cm³/10 min to 46 cm³/10 min, and the yellowness ranges from 1.12 to 1.19; by reducing the total content of the compounds represented by Formulas (A) to (C) in the thermoplastic resin, the MVR and the yellowness of the thermoplastic resin can be significantly improved.

TABLE 2

| | | | Comparative |
|---|---|---|---|
| | Application | Application | Application |
| | Example 1 | Example 2 | Example 1 |
| Film thickness (μm) | 97 | 103 | 99 |
| Haze (%) | 2.54 | 2.50 | 2.61 |
| Total luminous | 87.75 | 87.83 | 87.70 |
| transmittance (%) | | | |
| Glass transition | 149.12 | 147.91 | 145.15 |
| temperature (° C.) | | | |
| MVR (cm³/10 min) | 47 | 45 | 49 |
| Abbe number | 22.9798 | 23.5174 | 23.6419 |
| Refractive index | 1.6464 | 1.6482 | 1.6342 |

As can be seen from the analysis of data in Table 2, the films prepared from the thermoplastic resins of the present application in Application Examples 1 to 2 have higher refractive indexes, higher heat resistance and lower Abbe numbers than the film prepared from the existing optical thermoplastic resin in Comparative Application Example 1.

The applicant states that the above are the specific embodiments of the present application and are not intended to limit the protection scope of the present application. Those skilled in the art should understand that any changes or substitutions easily conceivable by those skilled in the art within the technical scope disclosed in the present application fall within the protection scope and the disclosed scope of the present application.

1. A thermoplastic resin, prepared from raw materials comprising at least one of a carbonic acid diester or a dicarboxylic acid compound and a dihydroxy compound;
wherein the dihydroxy compound comprises: a dihydroxy compound represented by Formula (1); and
any one or a combination of at least two of a compound represented by Formula (A), a compound represented by Formula (B) or a compound represented by Formula (C); 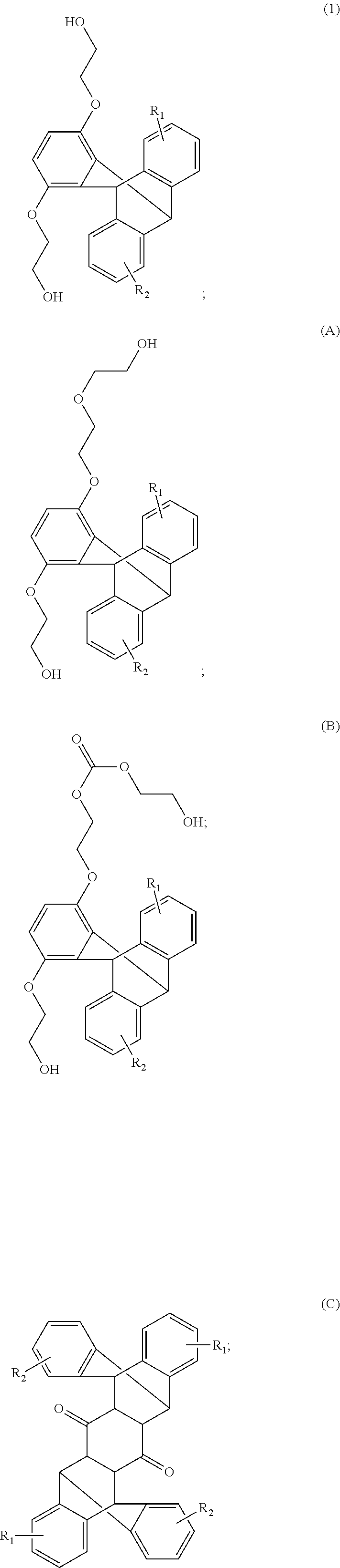
wherein in Formula (1), Formula (A), Formula (B) and Formula (C), R₁ and R₂ are each independently selected from a hydrogen atom, alkyl having 1 to 20 carbon atoms, alkoxy having 1 to 20 carbon atoms, cycloalkyl having 5 to 20 carbon atoms, cycloalkoxy having 5 to 20 carbon atoms, aryl having 6 to 20 carbon atoms or aryloxy having 6 to 20 carbon atoms;
a total weight of the compound represented by Formula (A), the compound represented by Formula (B) and the compound represented by Formula (C) is 1500 ppm or less with respect to 100 parts by weight of the dihydroxy compound represented by Formula (1).

2. The thermoplastic resin according to claim 1, wherein a weight of the compound represented by Formula (A) is 800 ppm or less with respect to 100 parts by weight of the dihydroxy compound represented by Formula (1);
a weight of the compound represented by Formula (B) is 300 ppm or less with respect to 100 parts by weight of the dihydroxy compound represented by Formula (1);
a weight of the compound represented by Formula (C) is 200 ppm or less with respect to 100 parts by weight of the dihydroxy compound represented by Formula (1);
a proportion of the dihydroxy compound represented by Formula (1) is 1 mol % to 99.9 mol % based on the total substance amount of the dihydroxy compound being 100 mol %.

3. The thermoplastic resin according to claim 1, wherein the dihydroxy compound further comprises a dihydroxy compound represented by Formula (2) and/or a dihydroxy compound represented by Formula (3); 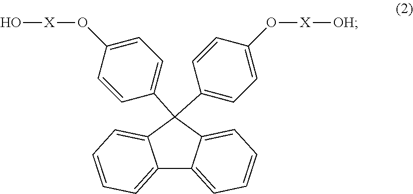
wherein in Formula (2), X is alkylene having 1 to 4 carbon atoms; 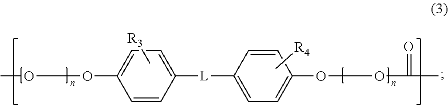
wherein in Formula (3), R₃ and R₄ are each independently selected from a hydrogen atom, alkyl having 1 to 20 carbon atoms, alkoxy having 1 to 20 carbon atoms, cycloalkoxy having 5 to 20 carbon atoms, aryl having 6 to 20 carbon atoms, aryloxy having 6 to 20 carbon atoms or a halogen atom;
Y is selected from alkylene having 1 to 8 carbon atoms, cycloalkylene having 6 to carbon atoms or arylene having 6 to 10 carbon atoms, and n is an integer of 0 to 5;
L is selected from a single bond or any one of the following groups: 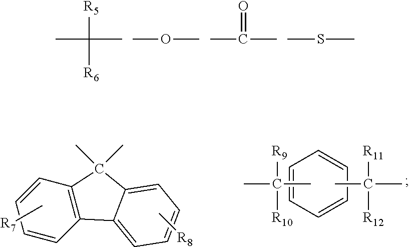
wherein R₅, R₆ and R₉ to R₁₂ are each independently selected from a hydrogen atom, alkyl having 1 to 10 carbon atoms or phenyl;
R₇ and R₈ are each independently selected from a hydrogen atom or alkyl having 1 to 5 carbon atoms;
a molar ratio of the dihydroxy compound represented by Formula (1) to the dihydroxy compound represented by Formula (2) is 20:80 to 99.9:0.1.

4. The thermoplastic resin according to claim 1, wherein a number average molecular weight of the thermoplastic resin is 10000 to 50000;
a glass transition temperature of the thermoplastic resin is 95° C. to 180° C.;
a phenol content of the thermoplastic resin is 0.1 ppm to 1000 ppm;
wherein the carbonic acid diester is any one or a combination of at least two of diphenyl carbonate, ditolyl carbonate, bis(chlorophenyl)carbonate, m-cresyl carbonate, dimethyl carbonate, diethyl carbonate, dibutyl carbonate or dicyclohexyl carbonate;
the dicarboxylic acid compound is any one or a combination of at least two of 2,7-naphthalenedicarboxylic acid, 2,6-naphthalenedicarboxylic acid, 2,3-naphthalenedicarboxylic acid, 1,8-naphthalenedicarboxylic acid, 1,4-naphthalenedicarboxylic acid, terephthalic acid, isophthalic acid, phthalic acid, 2-methylterephthalic acid, biphenyldicarboxylic acid, tetrahydronaphthalenedicarboxylic acid, fluorene-9,9-dipropionic acid, oxalic acid, malonic acid, succinic acid, maleic acid, fumaric acid, glutaric acid, adipic acid, pimelic acid, octanedioic acid, nonanedioic acid, decanedioic acid, decanedicarboxylic acid, dodecanedicarboxylic acid, cyclohexanedicarboxylic acid, decahydronaphthalenedicarboxylic acid, norbornanedicarboxylic acid, tricyclodecanedicarboxylic acid, pentacyclododecanedicarboxylic acid, 3,9-bis(1,1-dimethyl-2-carboxyethyl)-2,4,8,10-tetraoxaspiro[5,5]undecane or 5-carboxy-5-ethyl-2-(1,1-dimethyl-2-carboxyethyl)-1,3-dioxane or dimer acid;
a total amount of at least one of the carbonic acid diester or the dicarboxylic acid compound is 0.97 mol to 1.20 mol with respect to 1 mol of the dihydroxy compound.

5. (canceled)

6. A method for preparing the thermoplastic resin according to claim 1, comprising the following steps:
mixing raw materials for preparing a thermoplastic resin and performing a reaction to obtain the thermoplastic resin.

7. The preparation method according to claim 6, wherein the reaction is carried out in the presence of a catalyst;
the catalyst is selected from any one or a combination of at least two of an alkali metal compound, an alkaline-earth metal compound or a nitrogen-containing compound; an amount of the catalyst used is such that a molar ratio of the total of a compound having a structure represented by Formula (1) to the catalyst is 1:(10⁻⁸ to 10⁻⁴);
wherein the reaction is carried out in the following reaction conditions: a resulting mixture is heated to 150° C. to 190° C. under atmospheric pressure, the reaction is carried out for 5 min to 15 min, the pressure is reduced to 20 kPa to 30 kPa, and the reaction is continued for 20 min to 40 min; the mixture is heated to 200° C. to 220° C., the pressure is reduced to 10 kPa to 18 kPa, and the reaction is carried out for 15 min to 25 min; the mixture is heated to 230° C. to 270° C., the pressure is reduced to 3 kPa to 6 kPa, and the reaction is carried out for 10 min to 25 min; the mixture is heated to 240° C. to 290° C., the pressure is continuously reduced to 0.05 kPa to 0.5 kPa, and the reaction is continued for 50 min to 90 min; after the reaction is completed, the heating is stopped and nitrogen gas is introduced to obtain the thermoplastic resin.

8. (canceled)

9. A molded body molded from the thermoplastic resin according to claim 1;
wherein the molded body comprises a lampshade, an automobile lamp lens, a signboard, a laser printing film or a display lamp.

10. An optical material prepared from a raw material comprising the thermoplastic resin according to claim 1.

11. An optical lens prepared from a raw material comprising the thermoplastic resin according to claim 1.

12. An optical film prepared from the thermoplastic resin according to claim 1.
